(19) United States
(12) Patent Application Publication
(10) Pub. No.: US 2011/0098090 A1
(43) Pub. Date: Apr. 28, 2011

(54) BIOLOGICAL PROTECTION DEVICE AGAINST THE ELECTROMAGNETIC WAVES EMITTED BY A MOBILE TELEPHONE

(75) Inventors: Serge Parienti, Boulogne-Billancourt (FR); Cyril Mourali, Paris (FR); Joseph Saillard, Saint Herblain (FR); Janic Chauveau, Blain (FR); Marc Brunet, Saint Julien De Concelles (FR)

(73) Assignees: DEPHASIUM Ltd, London (GB); UNIVERSITE DE NANTES, Nantes cedex 1 (FR)

(21) Appl. No.: 12/604,027

(22) Filed: Oct. 22, 2009

(51) Int. Cl. H04B 1/38; H04M 1/00

(52) U.S. Cl. 455/566; 455/575.1

(57) ABSTRACT

The present invention concerns the field of individual biological protection devices against emissions of electromagnetic pollution, more particularly a biological protection device against the electromagnetic waves emitted by a mobile telephone.

The device includes a frame (3) and a screen (4) made at least in part from a highly-conducting metallic material, with the screen having dimensions that are sufficient to cover the internal perimeter of the frame (3), the screen (4) and the frame (3) forming a protective element (1) that is open and proof against the electromagnetic waves, when the screen is covering the frame.

The mobile telephone (2) is held within the depth of the protective element so that the screen is located facing the ergonomic interface (21) of the mobile telephone with an electrically insulating space with a thickness of at least 2 mm between the metallic part of protective element and the mobile telephone.

This present invention concerns the field of individual biological protection devices against emissions of electromagnetic pollution.

More particularly, this present invention concerns a biological protection device against the electromagnetic waves emitted by a mobile telephone.

In a wireless world, in which individuals are constantly connected, mobile technologies of every kind proliferate and, as a consequence, so does the generation of electromagnetic waves. Thus, most of the population in the developed countries possess a whole range of radiating appliances, such as mobile and wireless telephones (more than 2 billion subscribers currently, and 3 billion predicted in 2010), computers (1 billion computers sold), WiFi modems (1 billion Internet subscribers, eventually all to be WiFi), game consoles, Bluetooth earpieces, and so on.

The increasing density of electromagnetic sources in our environment raises practical questions concerning effects on health, and the case of the mobile telephone is the most significant of these. In fact, this segment of the telecommunications market is undergoing phenomenal growth, and since its appearance on the market, the mobile telephone has been raising the most severe doubts concerning the exposure of individuals to its electromagnetic radiation, which is powerful, continuous and close to the brain.

Up to the present time, the question of harm has met with no concrete and definitive response, and the polemic is at its height. Many international studies conducted on the subject have oscillated in their conclusions between a “health catastrophe” and “a slight risk”, without ever concluding that the risk is zero.

In France, following publication of the Decree dated Oct. 8, 2003, mobile telephones must have a Specific Absorption Rate (SAR) of less than 2 W/kg on 10 g of human tissue in the regions of the trunk and head, where the SAR is a fundamental magnitude associated with the heating of the tissues. In the United States, the Federal Communications Commission requires that all mobile telephones sold must have a SAR of not more than 1.6 W/kg on a mass of one gram of human tissue. The most recent mobile telephones to appear on the market are still emitting electromagnetic radiation with a Specific Absorption Rate of the order of 1 W/kg. In any event, the lack of perspective and the remaining uncertainties forcibly impose the precautionary principle, a constitutional principle in the name of which it appears necessary to develop individual biological protection devices for use to limit exposure to electromagnetic pollution affecting the human body.

The prior art already deals with passive antenna systems that afford biological protection against a large spectrum of frequencies of electromagnetic waves, which come in the form of a range of patches which need only to be applied onto the mobile technology equipment and between the said equipment and the user, in order to protect the user from the electromagnetic waves emitted by the equipment. These systems use the physical principle of phase-shifting the electromagnetic waves by 180°.

However, due to the small size of the patch in relation to the size of the mobile equipment, performance is necessarily limited. Moreover, these techniques are ill-suited or not suited to the standard protocols for measurement of the SAR.

The purpose of this present invention is to overcome one or more drawbacks of the prior art by proposing a biological protection device against the electromagnetic waves emitted by a mobile telephone.

This objective is attained by a biological protection device against the electromagnetic waves emitted by a mobile telephone which is characterised in that it includes at least a frame and a screen, where the length and width dimensions of the screen are sufficient to cover at least the internal perimeter of the frame, with the screen and the frame being connected, at one of their corners, by a pivot link whose axle is perpendicular to the screen and to the frame, in order to allow pivoting of the screen in relation to the frame, at least in one direction and between two positions, namely a position with the frame covered by the screen and a position where the frame is not covered by the screen,

the screen and the frame each being made at least in part from a highly-conducting metallic material, with these parts being arranged either to provide electrical continuity between them, or so that the space between the metallic part of the frame and the metallic part of the screen is less than 5 mm, at least when the screen is covering the frame,

the mobile telephone being held in the depth of the protective element with the screen located facing the ergonomic interface of the mobile telephone and maintaining, at all points, an electrically insulating space that satisfies relative dimensioning criteria between the metallic part of the protective element and the mobile telephone.

According to one particular feature, the electrically insulating space between the metal part of the protective element and the ergonomic interface of the mobile telephone has a thickness of at least 2 mm, and preferably between 3 mm and 8 mm.

According to another particular feature, the part of the screen made from a highly-conducting metallic material consists of a continuous or discontinuous metallization of the outer surface of the screen, the part of the frame made from a highly-conducting metallic material consists of a continuous or discontinuous metallization of the outer surface of the frame.

According to another particular feature, the relative dimensioning criteria consist of a length of the protective element of not less than 1.15 times the length of the mobile telephone, a width of the protective element of not less than 1.2 times the width of the mobile telephone, and a depth of the protective element of not less than 1.3 times the thickness of the mobile telephone.

According to another particular feature, the relative dimensioning criteria also include a length of the protective element that is preferably not more than 1.3 times the length of the mobile telephone, a width of the protective element that is preferably not more than 1.3 times the width of the mobile telephone and a depth of the protective element that is preferably not more than 1.6 times the thickness of the mobile telephone.

According to another particular feature, the outer surface of the screen is slightly rounded so as to obtain a concave part of the protective element.

According to another particular feature, the screen and/or the frame include one or more orifices of a size that is less than the wavelengths of the electromagnetic waves used in mobile telephony, with the orifice or orifices being located either facing the microphone and/or loudspeaker and/or any other device included in the mobile telephone and used to receive or emit acoustic waves, so that these acoustic waves are not altered by the protective element, or located facing the connectors of the mobile telephone.

According to another particular feature, the maintenance of the mobile telephone in the depth of the protective element is achieved by means of an attachment device in non-conducting, insulating material designed to be attached to at least one part of the edge of the frame while also pressing onto the back of the telephone, and maintenance of the space of at least 2 mm between the metallic part of the protective element and the ergonomic interface of the mobile telephone is achieved by means of a non-conducting, insulating material affixed onto at least one part of the inner edge of the frame, the mobile telephone thus being held gripped between the attachment device and the insulating material.

According to another particular feature, the attachment device is composed of two closure bars mounted on the protective frame opposite to the protective screen, with at least one of the two bars being articulated on the periphery of the frame between at least a position of opening and a position of closure.

According to another particular feature, a housing designed to accommodate a magnet is created in the edge of the inner surface of the screen, this magnet being arranged so as to attract a magnet held in a housing created in the outer edge of the frame facing the housing created in the edge of the inner surface of the screen, when the screen is at a position with the frame covered, so as to maintain the screen at a position with the frame covered.

According to another particular feature, the pivot link is arranged in a projection forming the corner of the screen, by which the screen is connected to the frame, and in a projection forming the corner of the frame, by which the frame is connected to the screen, with these projections from the screen and the frame fitting together, the axle of the pivot link being attached to the inner surface of the screen and to the centre of the projection from the screen so that it fits into a through hole created in the centre of the projection from the frame.

According to another particular feature, the axle of the pivot link is of a length that is determined so as to pass through, and at one end to extend beyond, the through hole created in the projection from the frame, with the extended end of the axle brought up against an axle stop in order to prevent the axle from exiting from the through hole, with the inner surface of the screen rubbing as it pivots against a part of the outer surface of the frame.

According to another particular feature, the projection from the screen includes a stud fixed alongside the axle of the pivot link and in an eccentric manner in relation to the latter, so that the stud mates with a removal of material created in the projection from the frame on the trajectory of rotation of the stud driven by the pivoting of the screen, with the mating of the stud with the removal of material limiting the pivoting of the screen in relation to the frame at least between the position with the frame covered by the screen and the position where the frame is not covered by the screen.

According to another particular feature, the projection from the screen includes a housing fixed alongside the axle of the pivot link and in an eccentric manner in relation to the latter, the housing being designed to accommodate a magnet, and the projection from the frame includes at least one borehole designed to accommodate a magnet, with the housing and each borehole being arranged so that the magnet housed in the screen passes in front of the magnet housed in each borehole in the frame on the pivoting trajectory of the screen in relation to the frame.

According to another particular feature, the magnet housed in the projection from the screen is arranged so as to attract a first magnet housed in a first borehole in the projection from the frame, maintaining the screen in position with the frame covered, and to attract a second magnet housed in a second borehole in the projection from the frame, maintaining the screen in the position where the frame is not covered.

According to another particular feature, a third magnet housed in a third borehole in the projection from the frame located between the first and second boreholes is arranged to push against the magnet housed in the projection from the screen, with the screen being located in an intermediate position between the covered position and the uncovered position, thus being pushed into one or other of these positions.

Other particular features and advantages of this present invention will appear more clearly on reading the description that follows, which makes reference to the appended drawings, in which:

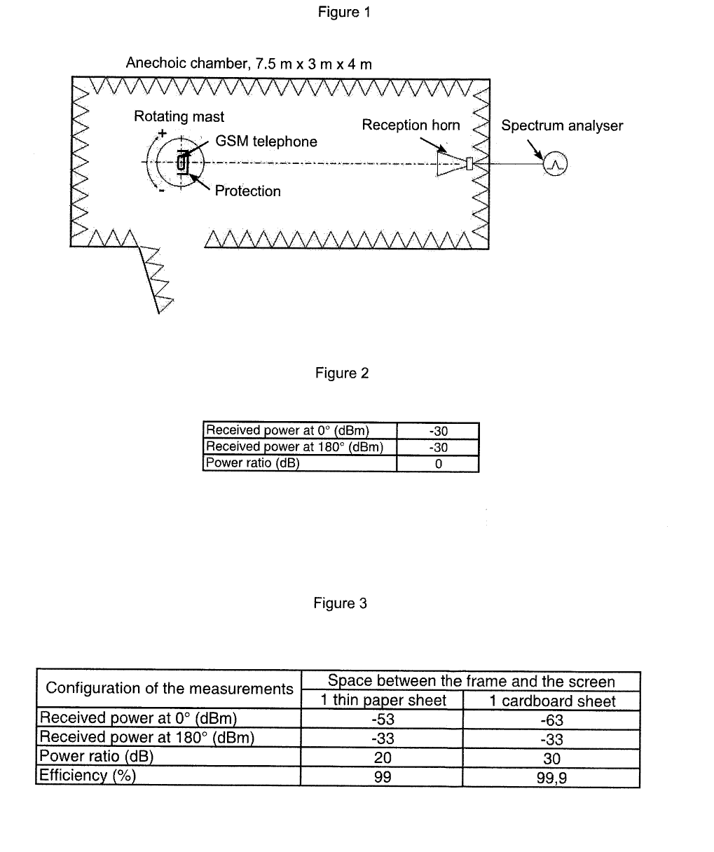

FIG. 1 schematically represents the test rig located in an anechoic chamber and set up for the measurements,

FIG. 2 is a table of measurements presenting the results obtained using the telephone with no protective element,

FIG. 3 is a table of measurements presenting the results obtained using the telephone with the protective element,

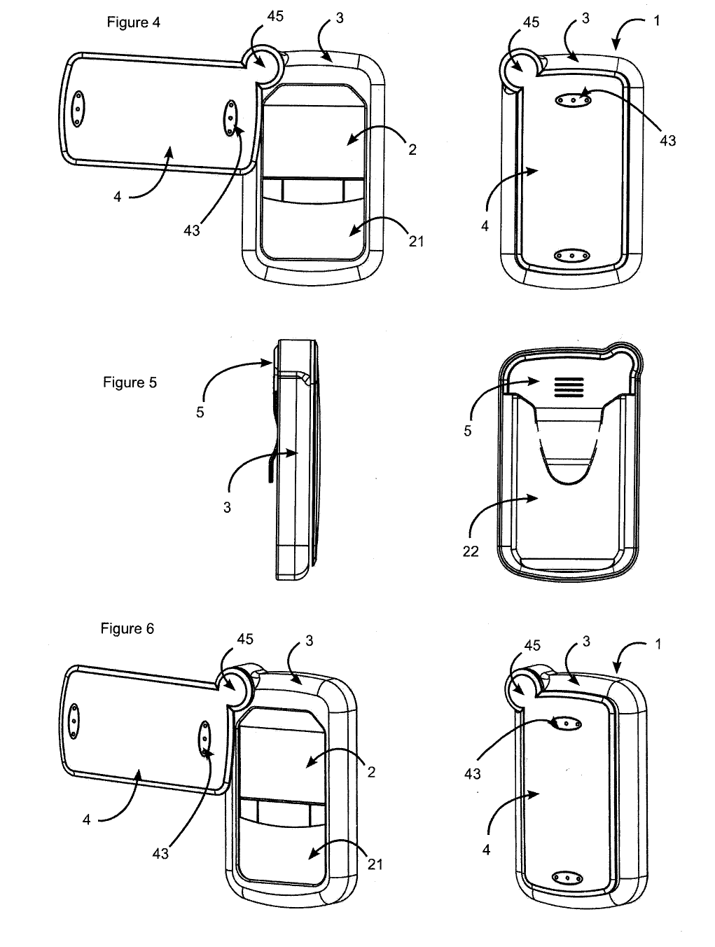

FIG. 4 represents a front view of the mobile telephone held in the frame with the screen in the uncovered position and the screen in the covered position,

FIG. 5 represents a view in profile and a rear view of the mobile telephone in the protective element of the invention,

FIG. 6 represents a three-quarter view of the mobile telephone held in the frame with the screen in the uncovered position and the screen in the covered position,

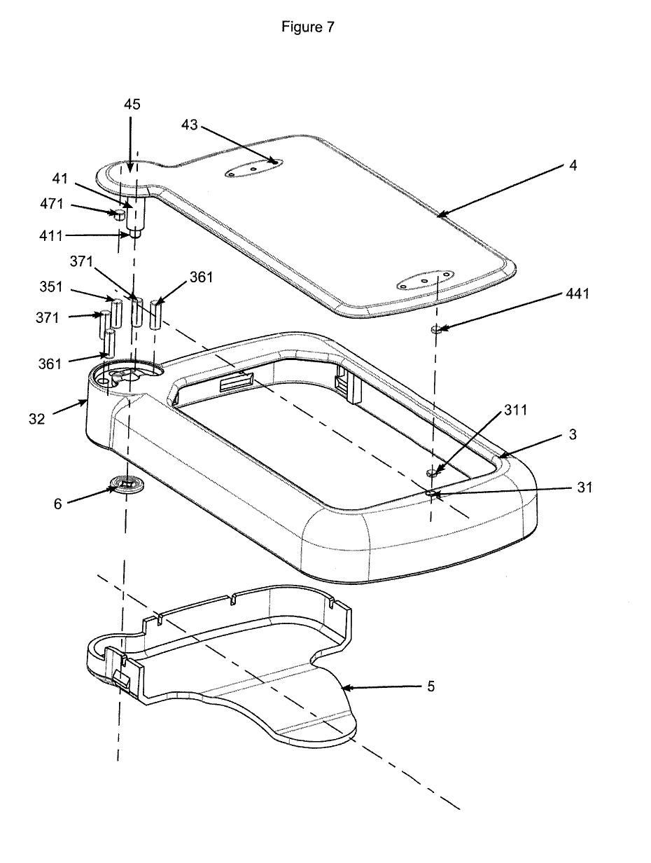

FIG. 7 represents a view in perspective of the exploded elements making up the protective device of the invention,

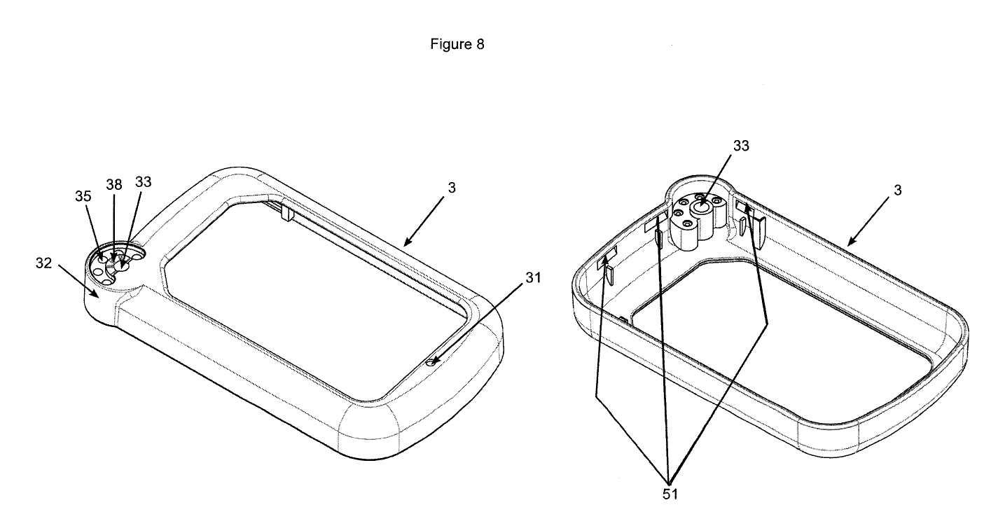

FIG. 8 represents a view in perspective of the outside and inside of the frame forming a part of the protective element of the invention,

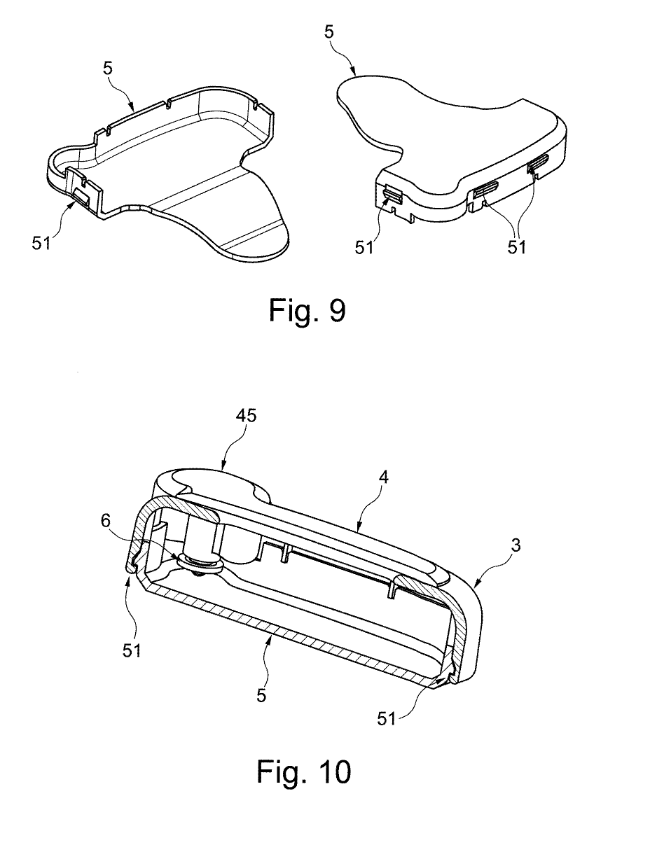

FIG. 9 represents a view in perspective of the inside and outside of the holding device of the invention,

FIG. 10 represents a view in lateral cross-section from above of the device of the invention,

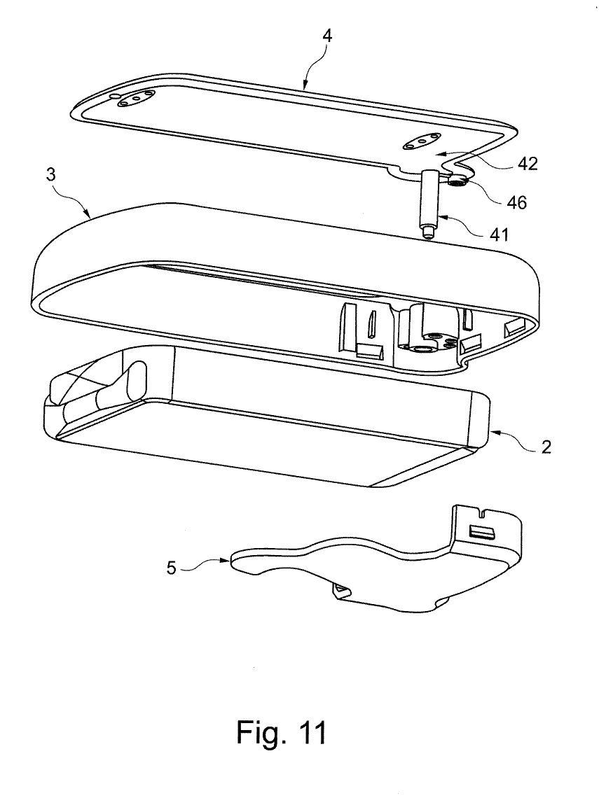

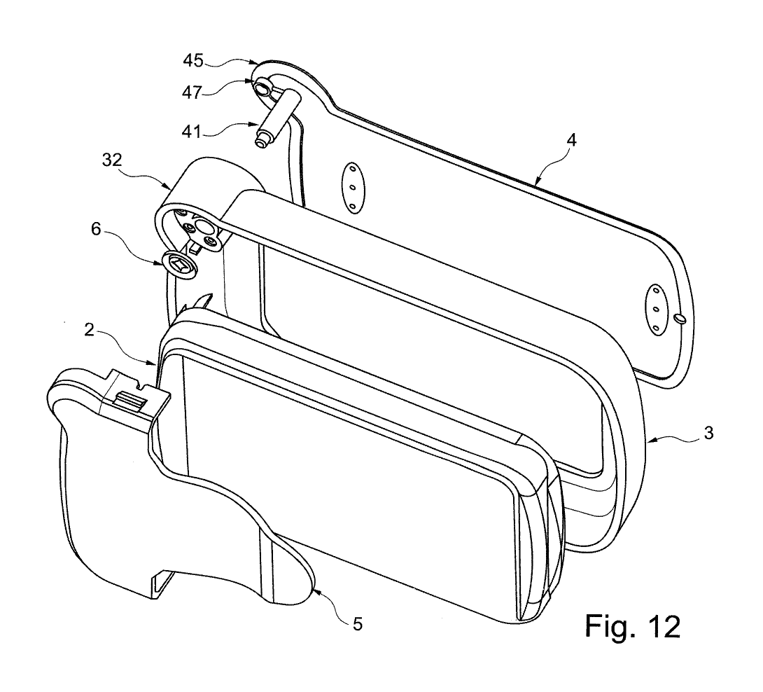

FIGS. 11 and 12 represent a view in perspective of the exploded elements making up the protective device of the invention, from the side and rear respectively,

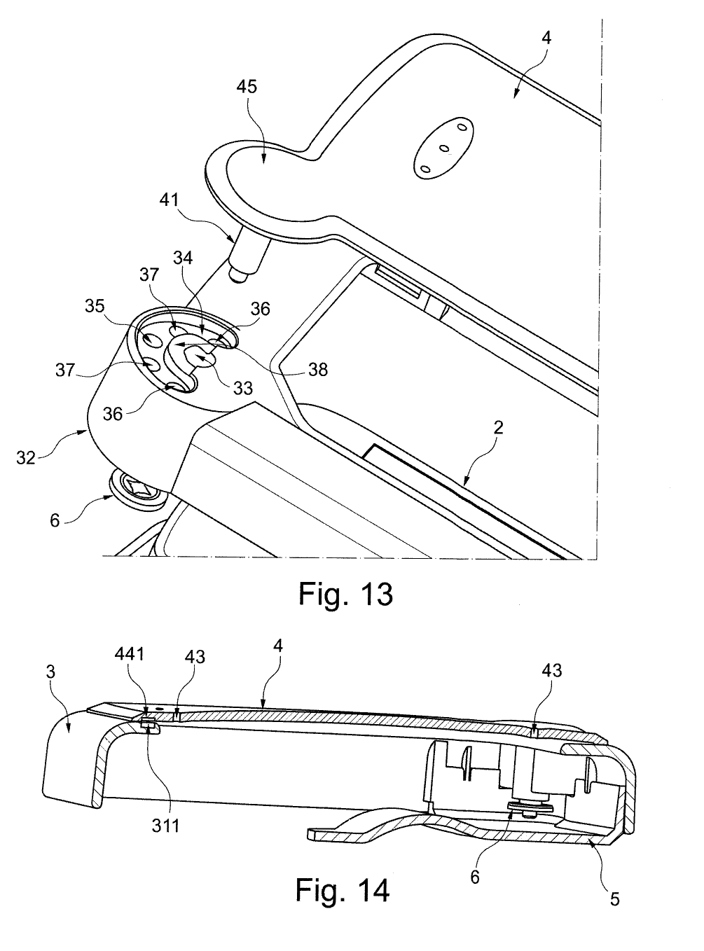

FIG. 13 represents an enlargement of the mechanism for indexing and limitating the pivoting of the screen in relation to the frame of the invention,

FIG. 14 represents a view in longitudinal cross-section of the device of the invention,

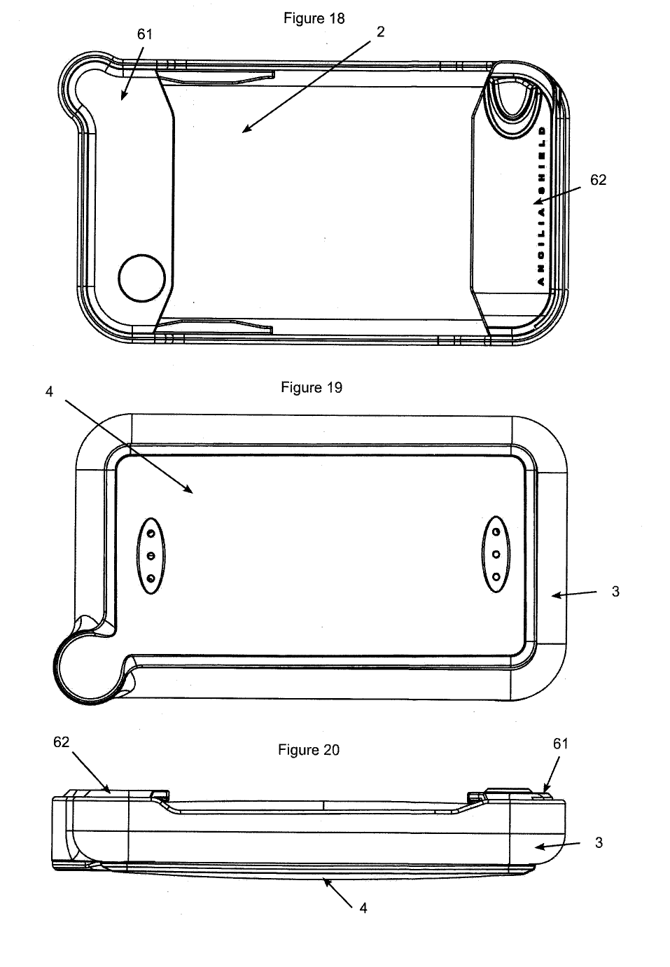

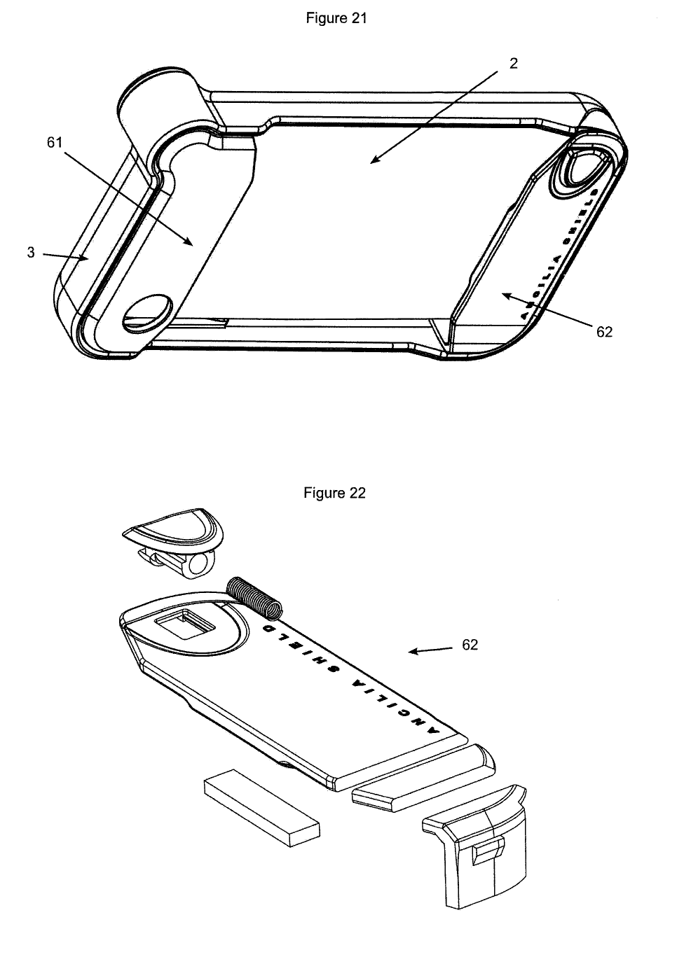

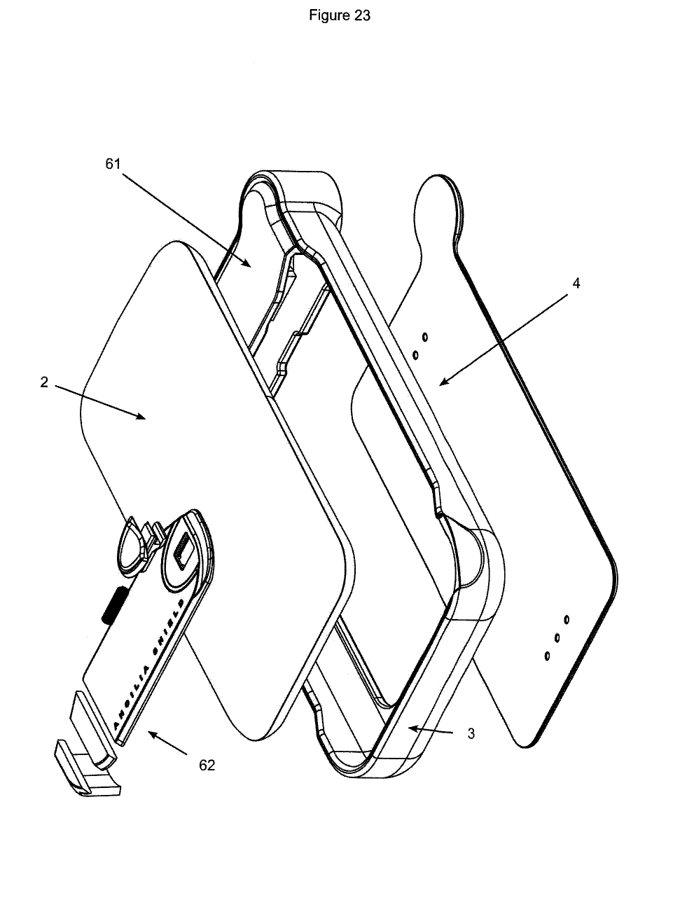

FIGS. 15 to 23 represent an embodiment of the invention in which the attachment device of the mobile telephone in the depth of the protective element has two closure bars situated opposite to the protective screen with respect to the protective frame, with FIGS. 15 to 17 illustrating more particularly the manner according to which the mobile telephone is inserted in, or removed from, the protective element.

The present invention proposes a device that constitutes, at least in a dedicated position, a protective element (1) for the user against the electromagnetic waves emitted by a mobile telephone (2). A mobile telephone is an appliance that we know very well in all of its forms, its functions, and its uses. Its continuous and powerful emissions of electromagnetic waves attain their full power during a telephonic communication. It is therefore during this particular use phase that the telephone is potentially most harmful, since it is also during this phase of use that the telephone is located close to or even up against the head of the user in the zone extending from the mouth to one of the ears. As a consequence, it is during this communication phase that it is all the more important to protect the user.

This simple observation, associated with the method of use of a mobile telephone, allows us to illustrate why it is necessary that the protective element (1) be arranged so as to be located between the mobile telephone (2) and its user during a wireless communication.

For the user, the protective element (1) should constitute a screen against the electromagnetic waves emitted by the mobile telephone (2). This characteristic proofing to the electromagnetic waves can be provided only by a highly-conducting material, such as copper. This is why the protective element (1) must be made at least in part from such a material.

If moreover, the mobile telephone (2) is held within the depth of the protective element, then the electromagnetic waves emitted by the mobile telephone (2) are not only reflected by the protective element (1) toward the mobile telephone, but also preferably along a direction away from the user. Since the protective element (1) has a significant depth in relation to the thickness of the mobile telephone, it is more effective than if it formed a simple flat finished surface.

However, it should be noted that the protection objective of the device according to this present invention can be attained in only certain conditions of which at least two are vital.

Firstly, the protective element (1) must be sufficiently deep to prevent the return of the electromagnetic waves to the user by edge effects along the edge of the protective element (1),
Secondly, the protective element (1) is composed, at least in part, of a highly-conducting metallic material, as are the antennae emitting or receiving electromagnetic waves, so it is necessary to ensure that the protective element (1) does not work for the user as an antenna but really as protection. To this end, it is necessary that the protective element (1) does not capture and amplify the electromagnetic radiation emitted by the mobile telephone (2). This is why it is necessary to electrically insulate the mobile telephone (2) and the metallic part of the protective element (1). This electrical insulation is effected by maintaining an electrically insulating space of at least 2 mm, at all points, between the mobile telephone (2) and the metallic part of the protective element (1). It should be noted that, for a space between the ergonomic interface of the mobile telephone and the metallic part of the protective element of 0.5 mm for example, the protective element conducts, or even amplifies, the electromagnetic waves emitted and/or received by the mobile telephone. It is also possible to specify an upper limit of the possible values for the electrically insulating space between the ergonomic interface of the mobile telephone (2) and the metallic part of the protective element (1). This upper limit is set to 10 mm, this choice being dictated only by the desire to preserve an assembly, formed of the mobile telephone and its protective element, that is mobile and of a suitable size and aesthetic appearance. Preferably, the electrically insulating space between the ergonomic interface of the mobile telephone (2) and the metallic part of the protective element (1) should have a value at all points of between 3 mm and 8 mm.
As a consequence, the length and width dimensions of the protective element (1) must be greater than the length and width dimensions of the mobile telephone (2). As a consequence also, the dimension in depth of the protective element (1) must be greater than the thickness of the electrically insulating space between the ergonomic interface of the mobile telephone and the metallic part of the protective element located facing the said ergonomic interface.

In the case of a metallization, which may be continuous or discontinuous, on an electrically insulating substrate of a given thickness, the electrically insulating space between the ergonomic interface of the mobile telephone and the metallic part of the protective element corresponds to the space between the ergonomic interface of the mobile telephone and the substrate, plus the given thickness of the substrate.

The choice of a protective element that is more or less deep and the choice of a particular value between 2 mm and 10 mm, preferably between 3 mm and 8 mm for the electrically insulating space between the mobile telephone (2) and the protective element (1), are preferably dependent on each other. In fact, many scientific tests of protection efficiency have been performed on the protective element of the invention, from which it emerges that the two aforementioned vital conditions are linked together in relation to the basic functional emission/reception capabilities of the mobile telephone. In particular, two important observations on this subject come out of these tests.

Firstly, for a mobile telephone (2) and a protective element (1) of fixed shape and dimensions, it can result from a small space between them, of less than 2 mm for example, a malfunction and/or a significant loss of performance of the mobile telephone regarding these basic functional emission/reception capabilities, this drawback being largely attenuated whenever the electrically insulating space reaches a value of at least 3 mm.
Secondly, for a given electrically insulating space between the ergonomic interface of the mobile telephone and the metallic part of the protective element, the deeper the protective element in relation to the thickness of the mobile telephone, the more significant the malfunction and the loss of performance of the mobile telephone. Because the telephone delivers signals of higher power in order to ensure the quality of the transmissions, any overheating and/or premature discharge of its battery, or more generally any reduction of its running time or life expectancy, can then be observed.
For its part, the quality of the protection against the electromagnetic waves emitted by the mobile telephone is slightly affected by the variation of these parameters and remains satisfactory within the limits specified in the present application, as demonstrated by the performance results presented at the end of this description.

The choice of a protective element that is more or less deep and the choice of a particular value of between 2 mm and 10 mm, preferably between 3 mm and 8 mm, of the electrically insulating space between the ergonomic interface of the mobile telephone and the metallic part of the protective element must therefore correspond to the search for a compromise between the quality of the protection provided and the quality of the telephonic communications. Moreover, the desire to preserve an assembly, namely the mobile telephone and protective element, that is both mobile and aesthetically pleasing, required the minimum dimensions. It is to this end that the specification is for an electrically insulating space of 10 mm maximum, and preferably of 8 mm maximum.

By way of a non-limiting example, the biological protection device against the electromagnetic waves emitted by a mobile telephone (2) includes at least a frame (3) and a screen (4) whose length and width dimensions are sufficient to cover at least the internal perimeter of the frame. The screen (4) and the frame (3) are connected, at one of their corners, by a pivot link whose axle (41) is perpendicular to the screen and to the frame. The pivot link must allow the pivoting of the screen (4) in relation to the frame (3), at least in one direction and between two positions. These two positions consist of a position with the frame covered by the screen and a position where the frame is not covered by the screen. For example, two pivoting directions and three positions of the screen in relation to the frame can be envisaged: a first position with the frame covered by the screen, a second position where the frame is not covered by the screen by pivoting the screen to the left of the frame, and a third position where the frame is not covered by the screen by pivoting the screen to the right of the frame.

In general, the idea is to enable the user to be protected from the electromagnetic waves emitted by the mobile telephone (2) when so desired, without losing the use of the ergonomic interface (21) of the mobile telephone (2). It is thus preferable that the position where the frame is not covered (3) by the screen (4) should fully free access to the ergonomic interface (21).

The screen (4) and the frame (3) are each made, at least in part, from a highly-conducting metallic material. These parts are arranged so as to provide electrical continuity between them and/or so that the space between the metallic part of the frame and the metallic part of the screen is less than mm, at least when the screen (4) is covering the frame (3).

This condition of electrical continuity and/or of spacing of less than 5 mm between the metallic part of the frame and the metallic part of the screen is necessary in order that the parts of the screen (4) and of the frame (3) that are made from a highly-conducting metallic material form a protective element (1) that is open and proof to the electromagnetic waves when the screen (4) is covering the frame (3). The protective element appears in effect like a rectangular parallelepiped that is open on one of its bases to form a receptacle. Moreover, the corners and the edges of said rectangular parallelepiped are preferably non-projecting, but rather rounded or bevelled. This characteristic is introduced in order to provide a protection device that is aesthetically pleasing, but also in order to prevent phenomena of multiple reflection of the electromagnetic waves within the depth of the protective element and thus to increase the quality of the protection afforded.

Thus, the person skilled in the art will understand that it is of little importance, for example, that the non-metallised parts of the protective device should have rounded or bevelled corners, but that it is important for the metallised parts to do so. For example, in the case of a metallization of the protective element on the outer surface of a substrate in insulating material in the shape of a rectangular parallelepiped, it is of little importance that the corners and the edges inside the parallelepiped should be rounded or bevelled, with these being made of insulating material and thus presenting no proofing properties against the electromagnetic waves. On the other hand, it is advantageous that the outside corners and edges of the parallelepiped should be rounded or bevelled, since these constitute or support the metallization or the screen of the outer surface of the parallelepiped.

Due to its proofing to the electromagnetic waves, the protective element (1) must not entirely cover the mobile telephone (2) since this would render impossible any communication protocol requiring the emission and/or reception by the mobile telephone (2) of electromagnetic waves to and/or from the outside respectively. This is why the protective element (1) must be opened.

This characteristic of the protective element (1) renders its design easier and its versatility broader. In fact, since it does not form a closed, but rather an open element, the dimensions of the protective element (1) are not restricted by the dimensions or the shape of the back (22) of the mobile telephone (2).

As mentioned previously, the mobile telephone (2) is held within the depth of the protective element (1) with the screen (4) located facing the ergonomic interface (21) of the mobile telephone (2) and maintaining, at all points, an electrically insulating space with a thickness of at least 2 mm, and preferably 3 mm to 8 mm, between the metallic part of the protective element (1) and the ergonomic interface of the mobile telephone (2).

The following relative dimensioning criteria are further given by way of a non-limiting example. The length of the protective element is not less than 1.15 times the length of the mobile telephone, the width of the protective element is not less than 1.2 times the width of the mobile telephone, and the depth of the protective element is not less than 1.3 times the thickness of the mobile telephone. The length of the protective element is preferably not more than 1.3 times the length of the mobile telephone, the width of the protective element is preferably not more than 1.3 times the width of the mobile telephone and the depth of the protective element is preferably not more than 1.8 times the thickness of the mobile telephone. The dimensions of the protective element in relation to the dimensions of the mobile telephone will need to be determined case by case, preferably within the range of values mentioned, in order to optimise the protection afforded, while also minimising the dimensions of the protective element.

For example, the outer surface of the screen (4) is metallised in a continuous or discontinuous manner, and the screen (4) has length and width dimensions which are more-or-less equal to the length and width dimensions of the mobile telephone (2). The frame (3) has outside dimensions that are equal to the aforementioned length and width dimensions of the protective element (1). The depth of the protective element (1) is approximately equal to the depth of the frame (3) plus the thickness of the screen (4).

By way of a non-limiting example, the part of the screen made from a highly-conducting metallic material (4) consists of a continuous or discontinuous metallization of the outer surface of the screen, up to a part of the edge of the inner surface of the screen, for example. Discontinuities in the metallization are acceptable if their characteristic size remains less than the various wavelengths of the different mobile telephone standards. Thus, the metallization can consist of a mesh with a grill interval, regular or not, that is not more than 10 mm, made of highly-conducting material that constitute conducting lines which can have a width of 0.5 mm and a thickness of 50 microns, with this metallic mesh being incorporated intoed or screen-printed onto the outer surface of the screen for example. Likewise, the part of the frame made from a highly-conducting metallic material (3) consists of a continuous or discontinuous metallization of the outer surface of the frame. The electrical continuity between these two metallic parts of the frame and the screen is provided by a conducting part of the pivot fink, by an electrical contact track (42) for example, consisting of a metallization of the inner surface of the screen around the axle (41) of the pivot link, and/or by contact between the frame and the screen, so that the metallic part of the frame and the metallic part of the screen are spaced apart by less than 5 mm. As an example, the electrical contact track (42) goes all around the axle (41) of the pivot link or only part of it. Because the metallization of the screen (4) is covering up to a part of the edge of the inner surface of the screen for example, it also contributes to the electrical continuity between the metallic parts of the frame (3) and of the screen (4), in particular if the screen is pressed against the frame.

It should be noted that electrical continuity at least at one point between the protection frame and the protection screen is preferable to the maintenance of a contact between the frame and the screen. However, because the mobile telephones emit electromagnetic waves at a frequency of approximately 1 GHz, corresponding to a wavelength of 30 cm approximately, while also preserving the electrical continuity between the frame and the screen, physical discontinuities that can range from a few millimetres to a few centimetres can be envisaged without altering the quality of the protection afforded by the device of the invention. In a scientific test conducted on this present invention, a certain number of sheets of paper are slipped between the protection screen and the protection frame in order to progressively space the screen from the frame, and the electrical contact between the screen and the frame is provided only by the electrical contact track going partially around the axle of the pivot link. The test demonstrated that within the limits of a separation of less than 2 mm between the frame and the screen, the quality of the protection remains satisfactory.

For example, the electrical continuity between the frame (3) and the screen (4) can indeed also be provided by an axle (41) of the pivot link that is at feast partially made from a highly-conducting material, and/or a washer in a highly-conducting material placed around the axle (41) of the pivot link and clamped between the screen (4) and the frame (3).

For example, the outer surface of the screen (4) is slightly rounded so as to create a concave part of the protective element (1), with the concave shape of the protective element increasing the quality of the protection afforded.

By way of a non-limiting example, the screen (4) and/or the frame (3) include one or more orifices (43) of characteristic size that is less than the wavelengths of the electromagnetic waves used in mobile telephony (2). This characteristic is necessary in order that the electromagnetic waves should be unable to pass through the orifices (43) to the user. Typically, orifices (43) of a characteristic size that is less than 1 cm do not alter the quality of the protection afforded. The orifice or orifices (43) are preferably located either facing the microphone and/or loudspeaker and/or any other device included in the mobile telephone (2) and used to receive or emit acoustic waves, so that these acoustic waves are not altered by the protective element (1), or are located opposite to the connectors of the mobile telephone.

Again by way of a non-limiting example, maintenance of the mobile telephone (2) in the depth of the protective element (1) is achieved by means of an attachment device (5) in non-conducting, insulating material designed to be attached, by clipping (51) for example, to at least one part of the edge of the frame (3), while also pressing onto the back of the telephone.

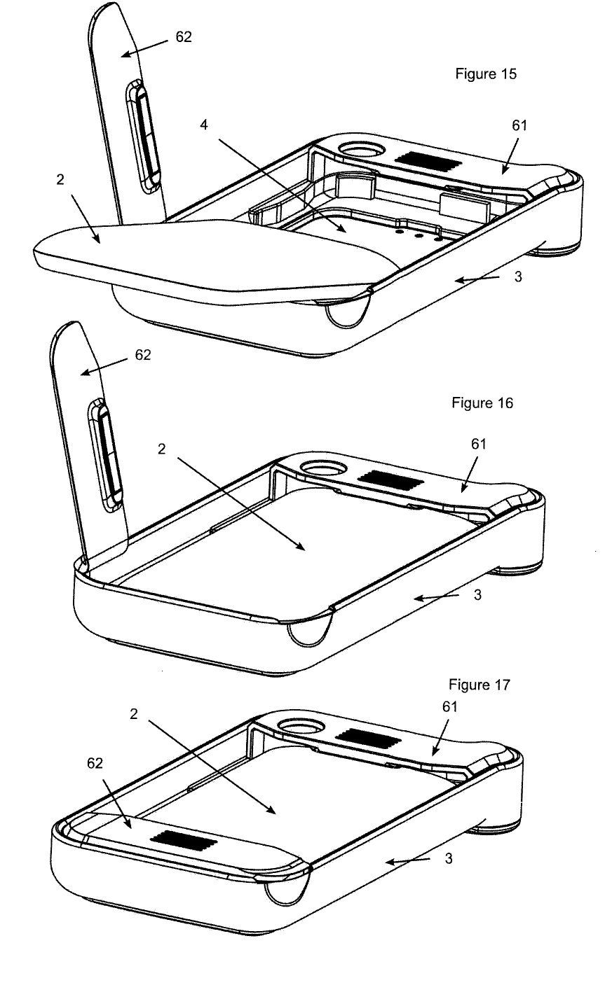

By way of a non-limiting example and as illustrated in FIGS. 15 to 23, maintenance of the mobile telephone (2) in the depth of the protective element (1) is achieved by means of an attachment device (6) in a non-conducting, insulating material, plastic or elastomeric, which is composed of two closure bars (61, 62) mounted on the protection frame. The two closure bars are located opposite to the protective screen with respect to the protective frame. In other words, the two closure bars are located in the back of the mobile telephone when the mobile telephone is placed within the depth of the protective element, the ergonomic interface of the mobile telephone being located opposite to the protective screen. For example, one (61) of the two closure bars is mounted in the top of the protective frame and the other (62) of the two closure bars is mounted in the bottom of the protective frame. At least one of the two closure bars is articulated on the periphery of the frame between a position of opening and a position of closure. For example and as illustrated on FIGS. 15 and 16, one (62) of the two bars (61, 62) is mounted to be articulated on the protection frame. For example, the articulation is an articulation of pivot type and the articulated closure bar pivots around the axle of the pivot link in the manner of a door. For another example, the articulation is an articulation enabling a sliding movement on the side of the articulated closure bar in the manner of a sliding. For example, the end of the closure bar opposite to the end articulated on the frame is well-arranged to engage the frame in the position of closure of the articulated closure bar. The engagement is ensured by a bolting/unbolting device, for example of the type of a latch, well-constructed in part in the said end of the closure bar opposite to the end articulated on the frame and in part in the intern periphery of the frame. Thus, the articulated closure bar can be pivoted or slid by the user from a position of closure towards a position of opening in order to facilitate for herself or himself the insertion of the mobile telephone into, or the removal of the mobile telephone from, the protective element (See more particularly FIGS. 15 to 17).

By way of a non-limiting example, maintenance of the space of at least 2 mm between the metallic part of the protective element (1) and the ergonomic interface of the mobile telephone (2) is achieved by means of an insulating material. This insulating material can be a foam (not shown) in non-conducting, insulating material for example, affixed onto at least one part of the inner edge of the frame (3). The mobile telephone (2) is then held clamped between the attachment device (5) and the insulating material within the depth of the protective element.

Firstly, although the function of the attachment device (5) is indeed to fix the mobile telephone (2) within the depth of the protective element (1), it can also act as a safety feature. In fact, the attachment device (5), as illustrated in the figures, covers a substantial part of the back (22) of the mobile telephone (2) so that a user who has put the telephone in the protective element (1) back-to-front will have no access to the ergonomic interface (21).

Secondly, it should be noted that the insulating material, namely the foam for example, can be supplied pre-installed or not with the protective device of the invention, or supplied separately, so that the user will be able, for example, to replace the foam with a new foam part when changing the mobile telephone (2) while still keeping the same protection device. In this latter case, means are provided in order to allow replacement of the foam and its maintenance.

By way of a non-limiting example, a housing (44) is created in the edge of the inner surface of the screen (4). This housing is designed to accommodate a magnet (441). This magnet (441) is arranged so as to attract a magnet (311) held in a housing (31) created in the outer edge of the frame (3) facing the housing (44) created in the edge of the inner surface of the screen, when the screen (4) is at a position with the frame covered (3). In this way, the screen (4) is more-or-less held when it is at a position with the frame covered (3).

By way of a non-limiting example, the pivot link is arranged as a projection (45) forming the corner of the screen (4), by which the screen is connected to the frame (3), and as a projection (32) forming the corner of the frame (3), by which the frame is connected to the screen. The axle (41) of the pivot link is fixed onto the inner surface of the screen (4) and to the centre of the projection (45) from the screen, so that it fits into a through hole (33) created in the centre of the projection (32) of the frame (3). Thus, the projections (45, 32) from the screen (4) and the frame (3) mate with each other.

By way of a non-limiting example, the axle (41) of the pivot link fixed to the screen (4) is of a length that is determined so as to pass through, and at one end to extend beyond, the through hole (33) created in the projection (32) from the frame (3). Thus, the extended end of the axle (41) can be brought up against an axle stop (6) in order to prevent the axle (41) of the pivot link exiting from the through hole (33). The length of the pivot axle (41) is also such that the inner surface of the screen (4) rubs against a part of the outer surface of the frame (3) during the pivoting of the screen in relation to the frame.

For example, the axle stop (6) can be metallic or made from an elastic plastic material. In this second case, it can exert an elastic return force on the screen (4), more particularly on the projection (45) from the screen, in the position butted up against the frame (3), and more particularly against the projection (32) from the frame.

It is interesting, in the case of a screen (4) mounted to pivot on the frame (3), that the pivot link can be arranged so that the pivoting action is limited and/or indexed and/or facilitated, between at least two covered or uncovered positions of the frame by the screen for example.

By way of a first non-limiting example, the pivoting of the screen (4) in relation to the frame (3) is limited by the following arrangement of the pivot link. The projection (45) from the screen includes a stud (46) fixed alongside the axle (41) of the pivot link and in an eccentric manner in relation to the latter. The stud (46) mates with a removal of material (34), created in the projection (32) from the frame (3) on the trajectory of rotation of the stud (46) driven by the pivoting of the screen (4). In this way, the pivoting of the screen (4) in relation to the frame (3), at least between the position with the frame covered by the screen and the position where the frame is not covered by the screen, is now limited by the mating of the stud (46) with the removal of material (34).

In the previously given example according to which two pivoting directions and three positions of the screen in relation to the frame are envisaged, the stud (46) of the screen (4) butts up against a first of the ends of the removal of material (34) of the frame (3) so that the screen (4) is in a position where the frame is not covered on the left and forms an angle of about 93° with the latter, or the stud (46) of the screen (4) butts up against a second of the ends of the removal of material (34) of the frame (3) so that the screen (4) is in a position where the frame is not covered on the right and forms an angle of about 90° with the latter.

By way of a second non-limiting example, the pivoting of the screen (4) in relation to the frame (3) is indexed by the following arrangement of the pivot link. The projection (45) from the screen includes a housing (47) fixed alongside the axle (41) of the pivot link and in an eccentric manner in relation to the latter. This housing (47) is designed to accommodate a magnet (471). Moreover, the projection (32) from the frame (3) includes at least one borehole designed to accommodate a magnet, each borehole being arranged so that the magnet (471) housed in the screen (4) passes in front of the magnet housed in each borehole in the frame (3) on the pivoting trajectory of the screen (4) in relation to the frame. For example, the magnet (471) housed in the projection (45) from the screen is arranged so as to attract a first magnet (351) housed in a first borehole (35) of the projection (32) from the frame (3), and to maintain the screen (4) in position with the frame covered (3). In this way, a first indexed position of the pivoting of the screen (4) in relation to the frame (3) corresponds to the position with the frame covered by the screen. Moreover, the magnet (471) housed in the projection (45) from the screen (4) can be arranged so as to attract a second magnet (361) housed in a second borehole (36) of the projection (32) from the frame (3), and to maintain the screen (4) in the position where the frame is not covered (3). In this way, a second indexed position of the pivoting of the screen (4) in relation to the frame (3) corresponds to the position where the frame is not covered by the screen. For example, a third magnet (371) housed in a third borehole (37) of the projection (32) from the frame (3) between the first and second borehole (35, 36) is arranged to push against the magnet (471) housed in the projection (45) of the screen (4). In this way, with the screen (4) located in an intermediate position between the covered position and the position where the frame is not covered (3), finds itself both pushed back by the third magnet (371) and more-or-less attracted by either of the first and second magnets (351, 361) and swings as a result to either of the covering positions or where the frame is not covered (3).

By way of a third non-limiting example, the pivoting of the screen in relation to the frame is facilitated by the following arrangement of the pivot link. A mechanical ramp (38) is arranged on the edge of the through hole (33) created in the projection (32) from the frame (3) to mate with a rib (48) created on the screen (4) so that it is adjacent to and radial to the axle (41) of the pivot link. The mechanical ramp (38) includes a notch in which the rib (48) is accommodated so as to maintain the screen (4) at a position with the frame (3) covered. Moreover, the mechanical ramp (38) includes a downward gradient from a top end of the notch, with the rib (48) sliding on this gradient so as to facilitate the pivoting of the screen (4) from a position of slight lifting of the screen at a top end of the notch up to the bottom of the gradient. The person skilled in the art will note that the pivoting is not only facilitated by the fact that the gradient is downward, but also by the slight lifting of the screen which limits the rubbing of the screen (4) on the frame (3), or even eliminates it over part of the pivoting trajectory, Likewise, an axle stop (6) with elastic properties can facilitate the pivoting of the screen (4) from a position of slight lifting of the screen at a top end of the notch up to the bottom of the gradient of the mechanical ramp (38), tending to return the screen (4) to a position butted up against the frame (3).

It is not only conceivable, but also advantageous and preferred, that these three examples above concerning the arrangement of the pivot link, or at least two of them, should be combined so that the pivoting of the screen (4) in relation to the frame (3) is limited and indexed and facilitated, and so as to more effectively maintain the screen at a position with the frame covered, in which the screen (4) and the frame (3) form the protective element (1). By way of a non-limiting example, the housing (47) of the screen (4), fixed alongside the axle (41) of the pivot link in an eccentric manner in relation to the latter and designed to accommodate a magnet (471), can simultaneously act as a stud (46), also fixed alongside the axle (41) of the pivot link in an eccentric manner in relation to the latter and mating with the removal of material (34) created in the projection (32) from the frame (3) on the trajectory of rotation of the stud (46) driven by the pivoting of the screen (4). Moreover, thus arranged, the pivot link means that the user does not have to assist the pivoting of the screen over all of its trajectory, and the latter merely has to trigger this pivoting action so that the screen places itself in a covering or non-covering position of the frame.

As an example in the case in which two pivoting directions and three positions of the screen in relation to the frame are envisaged, it is easy for someone skilled in the art to achieve the three arrangements given in the following example according to a symmetry (illustrated in the figures) that allows a first position with the frame covered (3) by the screen (4), a second position where the frame is not covered by the screen by pivoting the screen to the left of the frame, and a third position where the frame is not covered by the screen by pivoting the screen to the right of the frame, with the pivoting being limited and indexed and facilitated as described previously.

The protective device according to this present invention has been the subject of a scientific study conducted by Professor Joseph Saillard of the IREENA laboratory at the University of Nantes.

One should note firstly the results of a test that consists of measuring the quality of the protection afforded by the device of the invention in the presence, and then in the absence, of the magnets in the indexing system of the pivot link. This test revealed that the presence of the magnets does not affect the quality of the protection.

FIG. 1 schematically illustrates the test rig located in an anechoic chamber and set up for the measurements. This test rig includes a mobile telephone (2), whose dimensions in mm are 106×50×15, emitting continuous electromagnetic waves with a central frequency of 913 MHz. The test rig also includes a protective element (1) according to the invention, whose dimensions in mm are 122×67×26, a rotating mast, and a reception horn connected to a measuring resource or spectrum analyser located outside the anechoic chamber.

The power emitted by the mobile telephone (2) is read at the moment when the telephone establishes a link with a relay antenna during the reception of a call. This is a preferred moment for the measurements since the telephone is emitting a maximum of power at this instant.

The experiments are conducted leaving the door of the chamber ajar in order to guarantee a telephone/relay link and to minimise the arrival of multiple signal paths at the reception horn.

The results presented below are given for 2 angular positions:
0°: Front of the telephone to the reception horn, which corresponds to the position at which we seek to protect the user,
180°: Rear of the telephone to the reception horn, which corresponds to the position at which we seek to favour emission from the telephone.

Several tests were conducted for each of these measurement configurations in order to ensure consistency of the results. Since the value of the powers involve were able to change by a few dB between two measurements, only the most unfavourable value (the highest for 0° and the lowest for 180°) was retained. Thus, the resulting effectiveness is the minimum measured.

The table of FIG. 2 presents the results obtained using the telephone with no protective element (1).

In addition, measurements were also conducted with a thin sheet of paper, and then with a 1 mm thick cardboard sheet, slipped between the screen (4) and the frame (3) of the protective element (1).

The results are presented in the table of FIG. 3. The results obtained using the telephone with the protective element (1) are excellent, and show an attenuation of 30 dB, which is attenuation with an effectiveness of greater than 99% in relation to the power of the electromagnetic waves emitted, in the direction of the user, using the protective device according to this present invention.

In the present description, many specific details are provided for illustration and in no way limiting, so as to describe the invention in precise detail. The person skilled in the art will understand however that the invention can be implemented in the absence of one or more of these specific details or with the inclusion of variants. On other occasions, certain aspects are not described in detail so as to avoid over-complicating the present description, and the person skilled in the art will understand that many and varied other means can be employed, and that the invention is not limited only to the examples described.

It should be obvious to the person skilled in the art that the present invention allows implementation in many other specific forms while still not moving outside of the field of application of the invention as claimed. As a consequence, the present methods of implementation must be considered as illustrations only, which can be modified within the range defined by the scope of the attached claims, and that the invention must not be limited to the details given above.

1. A biological protection device against the electromagnetic waves emitted by a mobile telephone (2), characterised in that it includes at least a frame (3) and a screen (4), where the length and width dimensions of the screen are sufficient to cover at least the internal perimeter of the frame (3), with the screen (4) and the frame (3) being connected, at one of their corners, by a pivot link whose axle (41) is perpendicular to the screen (4) and to the frame (3), in order to allow the pivoting of the screen (4) in relation to the frame (3), at least in one direction and between two positions, namely a position with the frame covered (3) by the screen (4) and a position where the frame is not covered by the screen,
the screen (4) and the frame (3) each being made at least in part from a highly-conducting metallic material, with these parts being arranged either to provide electrical continuity between them, or so that the space between the metallic part of the frame and the metallic part of the screen is less than 5 mm, at least when the screen is covering the frame,
the mobile telephone (2) being held in the depth of the protective element (1), with the screen (4) located facing the ergonomic interface (21) of the mobile telephone (2) and maintaining, at all points, an electrically insulating space that satisfies relative dimensioning criteria between the metallic part of the protective element (1) and the mobile telephone (2).

2. A device according to claim 1, characterised in that the electrically insulating space between the metallic part of the protective element (1) and the ergonomic interface of the mobile telephone (2) has a thickness of at least 2 mm, and preferably between 3 mm and 8 mm.

3. A device according to claim 1, characterised in that the part of the screen made from a highly-conducting metallic material (4) consists of a continuous or discontinuous metallization of the outer surface of the screen, and the part of the frame made from a highly-conducting metallic material (3) consists of a continuous or discontinuous metallization of the outer surface of the frame.

4. A device according to claim 1, characterised in that the relative dimensioning criteria consist of a length of the protective element of not less than 1.15 times the length of the mobile telephone, a width of the protective element of not less than 1.2 times the width of the mobile telephone, and a depth of the protective element of not less than 1.3 times the thickness of the mobile telephone.

5. A device according to claim 1, characterised in that the relative dimensioning criteria also include a length of the protective element that is preferably not more than 1.3 times the length of the mobile telephone, a width of the protective element that is preferably not more than 1.3 times the width of the mobile telephone and a depth of the protective element that is preferably not more than 1.6 times the thickness of the mobile telephone.

6. A device according to claim 1, characterised in that the outer surface of the screen (4) is slightly rounded so as to obtain a concave part of the protective element (1).

7. A device according to claim 1, characterised in that the screen (4) and/or the frame (3) include one or more orifices (43) of a size that is less than the wavelengths of the electromagnetic waves used in mobile telephony, with the orifice or orifices (43) being located either facing the microphone and/or loudspeaker and/or any other device included in the mobile telephone (2) and used to receive or emit acoustic waves, so that these acoustic waves are not altered by the protective element (1), or located facing the connectors of the mobile telephone.

8. A device according to claim 1, characterised in that the maintenance of the mobile telephone (2) in the depth of the protective element (1) is achieved by means of an attachment device (5, 6) in non-conducting, insulating material designed to be attached to at least one part of the edge of the frame (3) while also pressing onto the back of the mobile telephone (2), and maintenance of the space of at least 2 mm between the metallic part of the protective element (1) and the ergonomic interface of the mobile telephone (2) is achieved by means of a non-conducting, insulating material affixed to at least one part of the inner edge of the frame (3), the mobile telephone (2) thus being held gripped between the attachment device (5) and the insulating material.

9. A device according to claim 8, characterised in that the attachment device (6) is composed of two closure bars (61, 62) mounted on the protective frame opposite to the protective screen, with at least one (62) of the two bars being articulated on the periphery of the frame between at least a position of opening and a position of closure.

10. A device according to claim 1, characterised in that a housing (44) designed to accommodate a magnet (441) is created in the edge of the inner surface of the screen (4), this magnet (441) being arranged so as to attract a magnet (311) held in a housing (31) created in the outer edge of the frame (3) facing the housing (44) created in the edge of the inner surface of the screen (4), when the screen is at a position with the frame covered, so as to maintain the screen at a position with the frame covered.

11. A device according to claim 1, characterised in that the pivot link is arranged in a projection (45) forming the corner of the screen (4), by which the screen (4) is connected to the frame (3), and in a projection (32) forming the corner of the frame (3), by which the frame is connected to the screen, with these projections (45, 32) from the screen (4) and the frame (3) fitting together, the axle (41) of the pivot link being attached to the inner surface of the screen (4) and to the centre of the projection (45) from the screen so that it fits into a through hole (33) created in the centre of the projection (32) from the frame (3).

12. A device according to claim 11, characterised in that the axle (41) of the pivot link is of a length that is determined so as to pass through, and at one end to extend beyond, the through hole (33) created in the projection (32) from the frame (3), with the extended end of the axle (41) brought up against an axle stop (6) in order to prevent the axle (41) form exiting from the through hole (33), with the inner surface of the screen (4) rubbing as it pivots against a part of the outer surface of the frame (3).

13. A device according to claim 11, characterised in that the projection (45) from the screen (4) includes a stud (46) fixed alongside the axle (41) of the pivot link and in an eccentric manner in relation to the latter, with the stud (46) mating with a removal of material (34), created in the projection (32) from the frame (3) on the trajectory of rotation of the stud (46) driven by the pivoting of the screen (4), with the mating of the stud (46) with the removal of material (34) limiting the pivoting of the screen (4) in relation to the frame (3) at least between the position with the frame covered by the screen and the position where the frame is not covered by the screen.

14. A device according to claim 11, characterised in that the projection (45) from the screen (4) includes a housing (47) fixed alongside the axle (41) of the pivot link and in an eccentric manner in relation to the latter, with the housing (47) being designed to accommodate a magnet (471), and where the projection (32) from the frame (3) includes at least one borehole (35) designed to accommodate a magnet (351), with the housing (47) and each borehole being arranged so that the magnet (471) housed in the screen (4) passes in front of the magnet housed in each borehole in the frame (3) on the pivoting trajectory of the screen in relation to the frame.

15. A device according to claim 14, characterised in that the magnet (471) housed in the projection (45) from the screen (4) is arranged so as to attract a first magnet (351) housed in a first borehole (35) of the projection (32) from the frame (3), maintaining the screen in position with the frame covered, and to attract a second magnet (361) housed in a second borehole (36) of the projection (32) from the frame (3), maintaining the screen in the position where the frame is not covered.

16. A device according to claim 15, characterised in that a third magnet (371) housed in a third borehole (37) of the projection (32) from the frame located between the first and the second boreholes (35, 36) is arranged to push against the magnet (471) housed in the projection (45) from the screen (4), with the screen being located in an intermediate position between the covered position and the uncovered position, thus being pushed into one or other of these positions.
